(19) United States
(12) Patent Application Publication
(10) Pub. No.: US 2007/0262171 A1
(43) Pub. Date: Nov. 15, 2007

(54) Spray head structure of a spray gun

(75) Inventor: Benson Wong, Hsin Chuang City (TW)

Correspondence Address: BIRCH STEWART KOLASCH & BIRCH, PO BOX 747, FALLS CHURCH, VA, 22040-0747, US

(73) Assignee: CHIA CHUNG PRECISION INDUSTRIAL CO., LTD.

(21) Appl. No.: 11/416,315

(22) Filed: May 3, 2006

(51) Int. Cl. B05B 1/28

(52) U.S. Cl. 239/296; 239/290; 239/518; 239/461; 239/525

(57) ABSTRACT

A spray head structure of a spray gun includes a block ring which is extended at a top end of wall between an inner and outer slot ring of a fixing seat. A surface of block ring, facing to a cap, is formed with a top cone surface for being tightly connected with a top cone of the cap, such that proper gaps can be formed between a cover ring of top cone surface and an inner wall of screw nut, and between a flange ring in an interior of top cone of cap and an outer wall of nozzle, which will completely separate an inner duct with an outer duct without mutually interfering, and is also provided with a proper effect of stabilizing a gas pressure.

### BACKGROUND OF THE INVENTION

a) Field of the Invention

The present invention relates to a spray head structure of a spray gun, and more particularly to a spray head structure which is assembled at a front end of a spray gun body and is provided with multiple leak-proof structures to avoid a mutual interference of gas flow between an inner duct and an outer duct after being assembled, and to stabilize an exit pressure of gas.

b) Description of the Prior Art

All of spray head products on the general market are designed to be more sophisticated to be in compliance with all kinds of various requirements. In addition, in considering a requirement of a stable and uniform exit flow of gas, a pressure stabilizing structure is usually installed in a passage through which a high pressure gas will pass, in order to mitigate a direct escape of the high pressure gas from a nozzle during a process of discharging, thereby affecting a performance of spraying operation. Referring to FIG. 1 and FIG. 2, in a Taiwan New Utility Patent 510253, “Spray Head Structure in which a Nozzle is Replaceable,” a sealing disc b, a connection seat c, a nozzle d, a spray head d, and a screw nut f are orderly assembled at a front end of spray gun a, wherein a front section of passage of an adjusting pin a1, extended from a center of surface of gas exit end at a head part of spray gun a, forms a screw hole for connecting to the connection seat c; the sealing disc b is installed between the end surface and the connection seat c; mutually corresponding inner and outer groove rings a2, a3, c1, c2 are formed on the end surface and a surface of the connection seat c which is facing to the end surface, respectively; the sealing disc b is correspondingly formed with a ring of slot holes b1; interiors of the inner and outer groove rings a2, a3 of the spray gun a are provided with an gas exit duct a4, respectively; an interior of the outer groove ring c2 of connection seat c is provided with a plurality of gas exit holes c21 which are transfixed to a groove space at a front end surface and segmented by a flange ring c22; a groove ring r4 is formed at a circumference of a hollow screw tube c3 at a front side of the connection seat c using an outer rim as a push surface c41, and a gas hole c11 in an interior of the inner groove ring c1 is embedded into a wall of the groove ring c4 for connection. On the other hand, the nozzle d is screwed at a front end of the connection seat c, its outer rim is formed with a disc d1 which is extended to an inner rim of the ring groove c4, and an interior of the spray head e is provided with a circular indentation e1 for holding the nozzle d. A circumference of end rim of the circular indentation e1 is formed with a push ring e11 which can be connected to the push surface c41 of groove ring c4 of connection seat c. The disc d1 is used to block a gas flowing from the gas hole c11 of inner groove ring c1 of connection seat c, the flange ring c22 is used to block a gas flowing from the gas exit holes c21 of outer groove ring c2 of connection seat c, and then the high pressure gas is discharged from gaps formed between the disc d1 and an inner ring wall of the spray head e, and between the flange ring c22 and an inner ring wall of the screw nut f, thereby achieving an effect of stabilizing the pressure.

Accordingly, this kind of nozzle of spray head is primarily designed to shorten a length of replaceable nozzle, and a pressure stabilizing structure formed by the disc and flange ring is in a right angle; therefore it is easy to generate an disorderly flow when air is flowing, and an original air pressure will be depleted in stabilizing the pressure, which required to be improved.

Accordingly, a brand new spray head structure of a spray gun is invented, wherein independent inner and outer ducts will be formed after the spray head is assembled at a front end of spray gun, such that gases separately flowing in the inner and outer ducts will not interfere with each other, and interiors of the inner and outer ducts are provided with its own pressure stabilizing structure, thereby being provided with a good effect of stabilizing the pressure.

### SUMMARY OF THE INVENTION

The primary object of present invention is to provide a spray head structure which can prevent a leakage of inner and outer ducts and is provided with a good effect of stabilizing a gas pressure.

Accordingly, the spray head structure of a spray gun of present invention comprises primarily a sealing disc, a fixing seat, a nozzle, a cap, and a screw nut which are orderly assembled at a front end of spray gun, wherein inner and outer groove rings are respectively formed on a surface the fixing seat, facing to the spray gun; corresponding inner and outer slot rings are formed on the other surface of fixing seat, with the inner groove ring being connected with the inner slot ring and the outer groove ring being connected with the outer slot ring by a plurality of gas holes; an inner wall of the inner slot ring of fixing seat is formed with a ring of cone surface facing toward a center, for being tightly connected with a ring of top rim at an outer wall of the nozzle; a top end of wall between the inner and outer slot rings is extended with a block ring, and a surface of which, facing to the cap, is formed with a top cone surface for being tightly connected with a top cone of a hollow tube of the cap; the top cone surface is forming a cover ring at an exterior of it, with a proper gap being formed between the cover ring and an inner wall of screw nut; and the top cone of hollow tube of cap is formed inward with a flange ring, with a proper gap between the flange ring and an outer wall of the nozzle.

According to the aforementioned structures, in assembling, the sealing disc is first installed between the spray gun and the fixing seat to connect with a gas passage between the gas exit hole of spray gun and the inner, outer slot rings of fixing seat, the nozzle is then screwed at a center of the fixing seat such that the ring of top rim at the outer wall of nozzle is tightly connected with the ring of cone surface at the center of fixing seat, and the cap is next aligned with the nozzle and fixed on the fixing seat with the screw nut, such that the top cone of hollow tube of cap is tightly connected with the top cone surface of block ring of fixing seat, and independent inner and outer ducts for gas flow are formed in the spray head. As the top cone is completely abutted on the top cone surface against its cone surface, the gas flowing in the inner and outer ducts will not interfere with each other. In addition, the gaps are formed between the flange ring of cap and the outer wall of nozzle, and between the cover ring of fixing seat and the inner wall of screw nut, which constitute the pressure stabilizing structures respectively, such that when the gas is flowing in the inner and outer ducts, it will be first blocked and then accumulated, and next will be uniformly ejected from the aforementioned gaps, thereby more stabilizing the pressure of ejected gas.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of a conventional spray head structure.

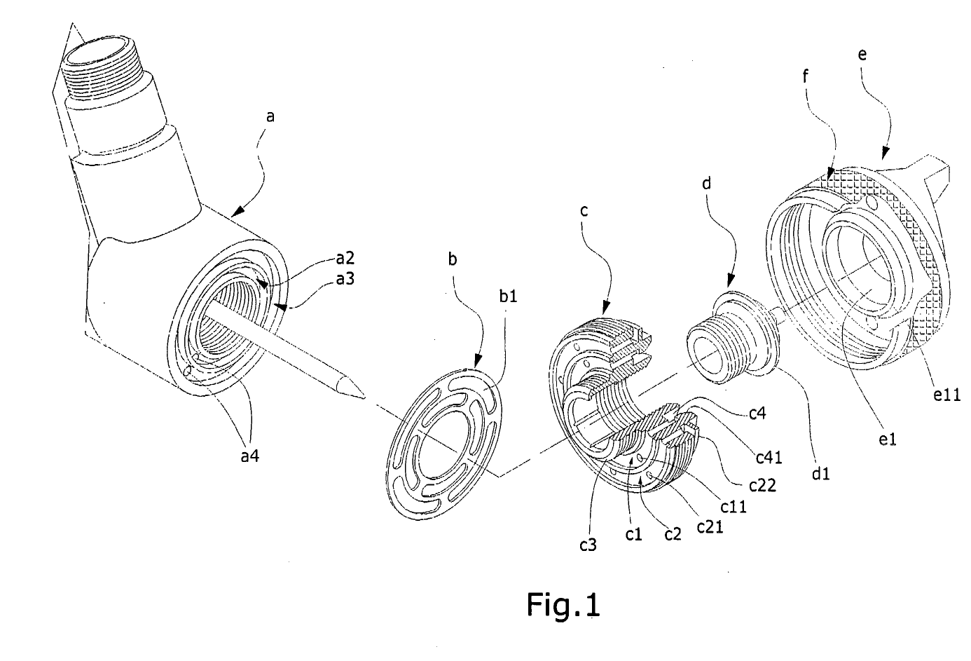

FIG. 2 shows a cutaway view of a conventional spray head structure after being assembled.

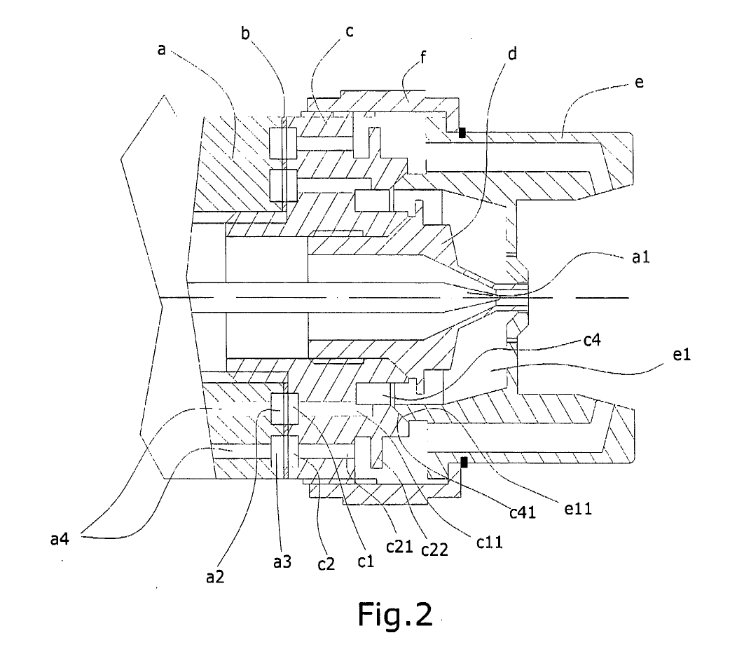

FIG. 3 shows an exploded view of the present invention.

FIG. 4 shows a cutaway view of the present invention after being assembled.

FIG. 5 shows a schematic view of a gas flow upon using the present invention.

### DETAILED DESCRIPTION OF THE PREFERRED EMBODIMENTS

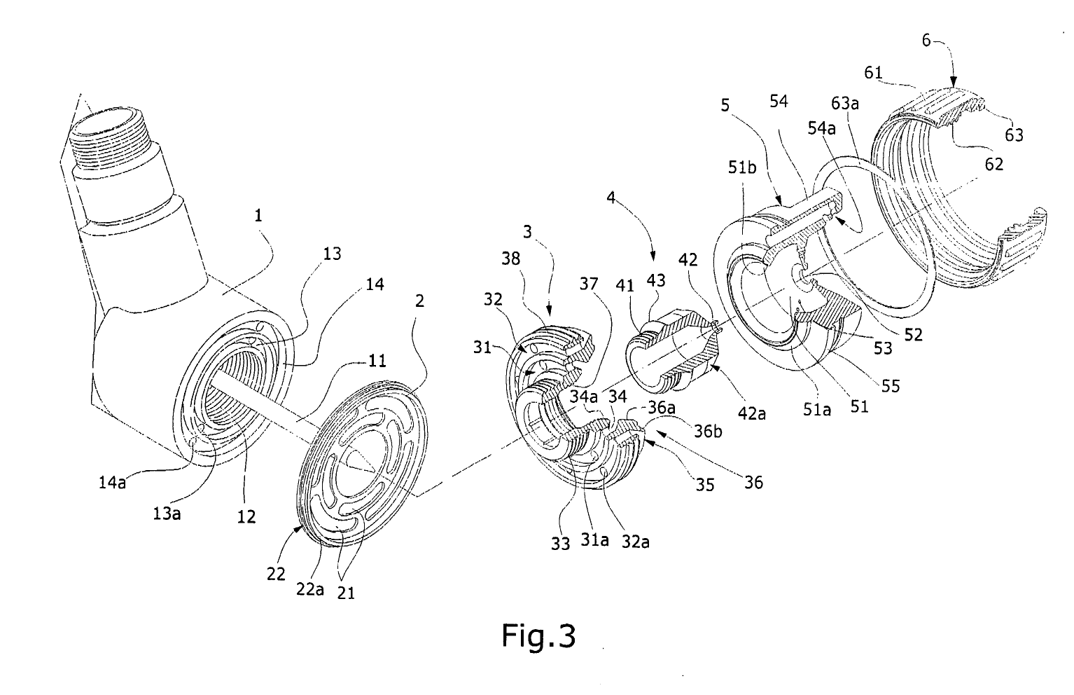

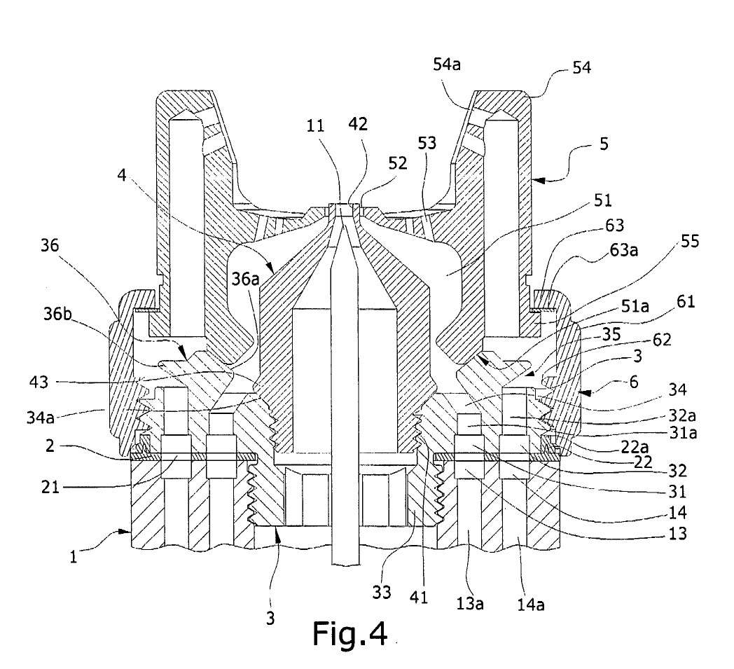

Referring to FIG. 3 and FIG. 4, in a spray head structure of a spray gun of the present invention, a sealing disc 2, a fixing seat 3, a nozzle 4, a cap 5, and a screw nut 6 are orderly assembled at a front end of spray gun 1. An adjusting pin 11 is extended from a center of front end part of the spray gun 1, and an inner wall of passage that the adjusting pin 11 passes through is provided with a thread part 12 for screwing with the fixing seat 3. An end surface of the spray gun 1 is formed with inner and outer groove rings 13, 14 which include gas exit ducts 13a, 14a respectively.

The sealing disc 2 is provided with a row of slot holes 21 separated with each other by a proper distance, corresponding to the aforementioned inner and outer groove rings 13, 14. In addition, an outer circumference of the sealing disc 1 is provided with a leak-proof side rim 22 on which is integrally enclosed by a leak-proof rubber 22a to prevent gas from escaping out of a connection place between the screw nut 6 and the spray gun 1.

An end surface of the fixing seat 3, facing to the inner and outer groove rings 13, 14 of the spray gun 1, is formed with corresponding inner and outer groove rings 31, 32, and a screw tube 33 corresponding to the thread part 12 of spray gun 1 is extended from a center of the fixing seat 3. On the other hand, an end surface of the fixing seat 3, facing to the nozzle 4, is formed with inner and outer slot rings 34, 35, and the inner and outer groove rings 31, 32 are respectively provided with a plurality of gas holes 31a, 32a equally separated with each other in a radial direction, by which they can be connected with the inner and outer slot rings 34, 35 at the other end surface. An inner wall of inner slot ring 34 is formed with a ring of cone surface 34a facing toward a center, and a top end of wall between the inner and outer slot rings 34, 35 is extended with a block ring 36. A surface of the block ring 36, facing to the cap 5, is formed with a top cone surface 36a which is tightly connected with the cap 5, and is forming a cover ring 36b at an exterior of the top cone surface 36a. A cone surface of the cover ring 36b is facing to a direction of gas flow, an inner wall at the center of the fixing seat 3 is provided with a thread part 37 for screwing with the nozzle 4, whereas an outer wall of the fixing seat 3 is provided with a thread part 38 for screwing with the screw nut 6.

An end of the nozzle 4 is a hollow screw tube 41 to be screwed into the thread part 37 of fixing seat 3, the other end of nozzle 4 is a tip tube 42, and an outer wall of the hollow screw tube 41 is formed with a ring of top rim 43 to be tightly connected with the ring of cone surface 34a of fixing seat 3. In addition, a circumference of the tip tube 42 is provided with a hexagonal sleeve 42a to be in cooperation with a tool for screwing the nozzle 4.

A center of the cap 5 is a hollow tube 51 which is made after cutting and processing a semi-sphere protruded on a bottom surface of the nozzle 4, an outer circumference at an opening of the hollow tube 51, corresponding to a top cone surface 43c, is provided with a top cone 51a. Therefore, the top cone 51a is in a curved surface in a cutaway view, and is integrally formed with a flange ring 51b toward an inner rim of opening of hollow tube 51; whereas a top surface of the hollow tube 51 is provided with a spray hole 52 into which the tip tube 42 can be transfixed. A plurality of turbo-holes 53 is located on a concentric ring at a periphery of the spray hole 52, an gas exit seat 54 is protruded at two sides of the other surface, a top end of the gas exit seat 54 is formed inward with a gas exit hole 54a, and an outer wall is provided with a flange ring 55 for locking the screw nut 6.

An outer wall of the screw nut 6 is provided with a knurl part 61, an inner wall is provided with a thread part 62 for screwing with the fixing seat 3, and an opening at the other end is formed inward with a lock ring 63 which can be latched with the flange ring 55 of cap 5, whereas an interior of the lock ring 63 is provided with a leak-proof piece 63a.

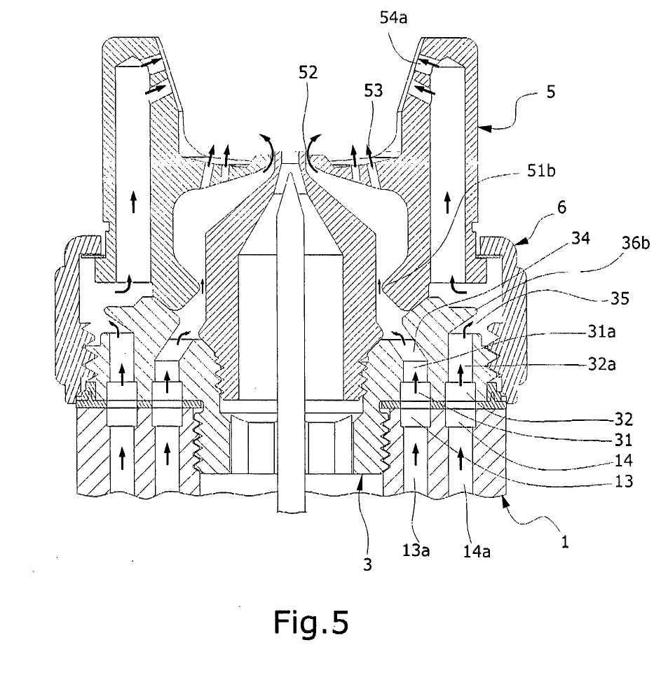

Referring to FIG. 5, when gas is discharged from the gas exit ducts 13a, 14a of spray gun 1, it will first flow into spaces formed by the inner, outer groove rings 13, 14 of spray gun 1 and the inner, outer groove rings 31, 32 of fixing seat 3, and will then flow through the gas exit holes 31a, 32a, to enter into the inner and outer slot rings 34, 35. At this time, the gas will be accumulated because it is blocked by the flange ring 51b of cap 5 and the cover ring 36b of fixing seat 3, then it will be sprayed out from gaps between the flange ring 51b and the outer wall of nozzle 4, and between the cover ring 36b and the inner wall of screw nut 6, and finally it will be ejected out from the spray hole 52, the turbo-holes 53, and the gas exit hole 54a of the cap 5, thereby achieving an effect of stabilizing the pressure.

Accordingly, in the spray head structure of spray gun of present invention, the inner and outer ducts are completely separated by the tight connection of the top cone and the top cone surface, thereby achieving an object of leak-proof. In addition, the improved structure is also provided with the effect of stabilizing the pressure of gas which is flowing in the inner and outer ducts.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A spray head structure of a spray gun comprising a sealing disc, a fixing seat, a nozzle, a cap, and a screw nut which are orderly assembled at a front end of spray gun to be used for a spraying operation, wherein a surface of fixing seat, facing to the spray gun, is respectively formed with inner and outer groove rings, the other surface of fixing seat is provided with corresponding inner and outer slot rings, with the inner groove ring being connected with the inner slot ring and the outer groove ring being connected with the outer slot ring by a plurality of gas holes; an inner wall of inner slot ring of fixing seat being formed with a ring of cone surface facing toward a center, for being tightly connected with a ring of top rim of outer wall of nozzle; a top end of wall between the inner and outer slot rings being extended with a block ring; a surface of the block ring, facing to the cap, being formed with a top cone surface for being tightly connected with a top cone of hollow tube of cap; the top cone being made by cutting and processing a semi-sphere protruded on a bottom surface of the nozzle, and being in a curved shape in a cutaway view; the top cone surface being formed with a cover ring at an exterior of it, with a proper gap being formed between the cover ring and an inner wall of the screw nut; the top cone of hollow tube of cap being formed inward with a flange ring, with a proper gap being formed between the flange ring and an outer wall of the nozzle.

2. The spray head structure of a spray gun according to claim 1, wherein the sealing disc is provided with a row of slot holes separated with each other by a proper position, corresponding to the inner and outer groove rings of spray gun, and an outer circumference of the sealing disc is provided with a leak-proof side rim on which is integrally enclosed by a leak-proof rubber.

3. The spray head structure of a spray gun according to claim 1, wherein a circumference of the tip tube at one end of the nozzle is provided with a hexagonal sleeve to be in cooperation with a tool for screwing the nozzle.
